(19) United States
(12) Patent Application Publication
(10) Pub. No.: US 2019/0370766 A1
(43) Pub. Date: Dec. 5, 2019

(54) COMPUTER SYSTEM AND COMPUTER-IMPLEMENTED METHOD FOR CARD-BASED EMAIL BANKING

(71) Applicant: MASTERCARD INTERNATIONAL INCORPORATED, PURCHASE, NY (US)

(72) Inventors: Gaurav K. Patni, Pune (IN); Ketan Shrikant Joshi, Pune (IN)

(21) Appl. No.: 16/296,768

(22) Filed: Mar. 8, 2019

(30) Foreign Application Priority Data
May 31, 2018 (SG) 10201804626U

(51) Int. Cl. G06Q 20/10; G06Q 20/34; G06F 17/27

(52) U.S. Cl. CPC G06Q 20/108; G06F 17/27; G06Q 20/351

(57) ABSTRACT

A payment network server for processing a card-based email payment is described, the server comprises at least a computer processor and a data storage device, the data storage device comprising instructions operative by the processor to: a) receive instructions via email to transfer a payment amount from a sender's card account to a recipient's card account, wherein at least a sender's card number associated with the sender's card account is included in a sender email address; b) analyse the email to extract the sender's card number and a recipient's card number associated with the recipient's card account; c) identify a recipient issuer server associated with the recipient's card number; d) submit a request to the recipient issuer server to credit the payment amount to the recipient's card account; and e) submit a request to the sender's issuer server to debit the payment amount from the sender's card account.

### CROSS-REFERENCE TO RELATED APPLICATION

This application claims the benefit of, and priority to, Singapore Patent Application No. 10201804626U filed May 31, 2018. The entire disclosure of the above application is incorporated herein by reference.

### FIELD

The present disclosure generally relates to a computer system and computer-implemented method for card-based email banking.

### BACKGROUND

This section provides background information related to the present disclosure which is not necessarily prior art.

Traditionally, for a user to transfer money from his/her bank account to that of someone else, the user needs to know the full name of the account holder, the account number and the bank identification number (BIN) or sort code before the user is able to instruct his/her own bank to transfer the money (e.g., by logging onto the user's internet banking portal). This is an inconvenient and tedious process with a high risk of error when entering the beneficiary's account details.

US 2016/0078448 describes methods and systems for transferring money using email. The sender can send an email message to the recipient and include a service email address operated by the system (e.g., by copying the message to the service email address). The system then queries a database to identify respective card accounts for the sender and recipient from their associated email addresses and identifies a payment amount from the email message content. The system then submits a request to a payment network to transfer the payment amount from the sender's card account to the recipient's card account. However, in this proposal, a dedicated system hardware is necessary to consult a pre-defined database to identify the card numbers of the parties involved in the transaction from their respective email addresses and to then instruct a payment network to carry out the transaction. This impacts processing time and associated set-up and running costs.

US 2013/0226789 describes techniques for enabling a user of an email application to exchange messages related to online transaction accounts. The email application may display a transaction account interface that enables a user to send specialised messages that may include money transfer instructions, money request instructions, and referral messages. A process flow is described for sending money to an email contact having an online transaction account by identifying the recipient and entering sender identification input (e.g., PIN or sender account number) plus the payment amount. The instructions are received and processed by a transaction system server which verifies the sender identification and initiates the transfer of the payment amount to the recipient account. However, this system requires a modified email application with a transaction account interface and an authentication process, both of which impact speed, convenience and ease of adoption of the system.

KR 1020000050091 describes a system to send or receive money or expenses for congratulations or condolences using email. The user must register for email banking and obtain a certification of membership. The remittance account number, password and amount are included in an email message, an email banking icon is selected and the remittance email sent. If the remittance email is confirmed/approved by the remittee, the user remits the amount to the remittee account. However, this system is vulnerable to fraud as a password is sent via email, which could be intercepted and misused.

WO 2011/133958 describes an inter-bank email and mobile invoicing network that enables customers to send invoices to a recipient email address. The recipient can review the invoice and conduct email communication with the sender for clarifications. The recipient can pay for the invoice using his/her bank account or a credit or debit card. Once the payment transaction is submitted, the network debits the source account and transfers funds directly to the bank account of the invoice sender. Although this system utilises emails for communication purposes, it still requires users to make payments using their respective bank accounts (e.g., via a bank application or website). Accordingly, the convenience of making a payment via email is lost.

Accordingly, none of the above provide complete convenience for the sender and recipient of the funds.

It is therefore an aim of the present disclosure to provide a computer system and computer-implemented method for card-based email banking, which addresses one or more of the afore-mentioned problems.

### SUMMARY

This section provides a general summary of the disclosure, and is not a comprehensive disclosure of its full scope or all of its features. Aspects and embodiments of the disclosure are set out in the accompanying claims.

In a first aspect of the present disclosure, there is provided a payment network server for processing a card-based email payment. The server comprises at least a computer processor and a data storage device, the data storage device comprising instructions operative by the processor to: (a) receive instructions via email to transfer a payment amount from a sender's card account to a recipient's card account, wherein at least a sender's card number associated with the sender's card account is included in a sender email address; (b) analyse the email to extract the sender's card number and a recipient's card number associated with the recipient's card account; (c) identify a recipient issuer server associated with the recipient's card number; (d) submit a request to the recipient issuer server to credit the payment amount to the recipient's card account; and (e) submit a request to the sender's issuer server to debit the payment amount from the sender's card account.

Thus, embodiments of the disclosure provide a payment network server configured to obtain a sender's card number directly from an email and to instruct a recipient issuer server to credit a payment amount to a recipient's card account, using only the recipient's card number identified from the email. Accordingly, embodiments of the disclosure require less processing time and incur less hardware set-up and maintenance costs than in the prior art since no additional servers and databases are required in order to obtain the sender's card number at least.

The sender's card number and/or the recipient's card number may each, respectively, identify one of a credit card or a debit card.

The instructions may be provided via an email application or by an email request from a sender issuer server associated with the sender's card account (e.g., via an issuer application or website).

The recipient's card number may be provided in the email or included in a recipient email address used in the email. Thus, the recipient's card number may also be extracted directly from the email without the need to consult a separate database thereby saving time and cost.

The sender email address and/or the recipient email address may include identification of the payment network server. In some embodiments, the payment network server may be identified via an email domain. For example, the sender email address and/or the recipient email address may be of the format [cardnumber]@[paymentnetwork].com. Thus, the sender need not copy in a system address to process the card-based email payment as the payment network server may operate the email domain and may automatically receive emails using that email domain.

The payment amount may be provided in a content, a subject or an attachment to the email.

Steps (d) and (e) may be performed in any order or concurrently.

The payment network server may be further configured to send an email confirmation to the sender email address and/or the recipient email address on successful completion of the card-based email payment.

The payment network server may be further configured for registering issuers for card-based email payments by: receiving an issuer registration request comprising bank identification numbers (BINs) for which cardholders are permitted to use a card-based email payments system; and transmitting to an issuer server associated with the issuer registration request, an email domain (e.g., a payment network server identifier) to be used by users of the card-based email payments system.

The issuer server may be configured for registering users for card-based email payments by: receiving a user registration request comprising a user-defined password; issuing a username having a format [cardnumber]@[emaildomain].com; and storing the password and username in a user database.

The payment network server may request that the issuer server verifies login credentials for a user by checking the password and the username provided via an email application for use of the card-based email payments system.

In some embodiments, the issuer server may store payee details in the user database on instruction by a user. For example, a user may store an identifier (e.g., in the form of a name, number or code) to be associated with a recipient's card number such that the identifier may be used instead of the recipient's card number in the email instructing a card-based email payment.

In a second aspect of the present disclosure, there is described a computer-implemented method for processing a card-based email payment. The method comprises: (a) receiving instructions via email to transfer a payment amount from a sender's card account to a recipient's card account, wherein at least a sender's card number associated with the sender's card account is included in a sender email address; (b) analysing the email to extract the sender's card number and a recipient's card number associated with the recipient's card account; (c) identifying a recipient issuer server associated with the recipient's card number; (d) submitting a request to the recipient issuer server to credit the payment amount to the recipient's card account; and (e) submitting a request to the sender's issuer server to debit the payment amount from the sender's card account.

In a third aspect of the present disclosure, there is provided a non-transitory computer-readable medium having stored thereon program instructions for causing at least one processor to perform the method according to the second aspect of the disclosure.

Thus, embodiments of the disclosure provide an email banking system which is easily accessible via a desktop, laptop, tablet or smartphone and is user-friendly as payments can be initiated through emails using common everyday language. There is no need for a user to login to an issuer application to conduct transactions as they can be initiated directly from an email application (e.g., Outlook). As the emails utilise a domain managed by a payment network server in conjunction with an issuer bank and users login to the email application using an internet banking personal identification number (IPIN) the system is secure and there is no need for any additional authentication of the user (e.g., via one-time password (OTP)). Furthermore, embodiments of the disclosure may provide easy access to a transaction history and statement (e.g., via sent and received emails).

Other desirable features and characteristics will become apparent from the subsequent detailed description and the appended claims, taken in conjunction with the accompanying drawings of the disclosure. Moreover, within the scope of this proposed disclosure it is expressly intended that the various aspects, embodiments, examples and alternatives set out in the preceding paragraphs, in the claims and/or in the following description and drawings, and in particular the individual features thereof, may be taken independently or in any combination. Features described in connection with one embodiment are applicable to all embodiments, unless such features are incompatible.

Further areas of applicability will become apparent from the description provided herein. The description and specific examples in this summary are intended for purposes of illustration only and are not intended to limit the scope of the present disclosure.

### DRAWINGS

Non-limiting embodiments of the disclosure will now be described for the sake of example only, with reference to the following drawings in which:

FIG. 1 shows a computerised network for processing a card-based email payment in accordance with a first embodiment of the disclosure;

FIG. 2 shows the steps of a method for processing a card-based email payment in accordance with an embodiment of the disclosure, and which may be performed by a payment network server comprised in the computerised network of FIG. 1;

FIG. 3 shows the steps of a method for registering an issuer with a payment network server for processing a card-based email payment in accordance with an embodiment of the disclosure;

FIG. 4 shows the steps of a method for registering a user for a card-based email payment in accordance with an embodiment of the disclosure;

FIG. 5 shows the steps of a method for processing a card-based email payment via an issuer application in accordance with an embodiment of the disclosure;

FIG. 6 shows the steps of a method for processing a card-based email payment via an email application in accordance with an embodiment of the disclosure;

FIG. 7 shows schematically the functional structure of the payment network server which may be used in the computerised network of FIG. 1 to carry out the methods of FIGS. 2 to 6 in accordance with an embodiment of the disclosure;

FIG. 8 shows schematically the structure of a server which may be used in the computerised network of FIG. 1 to implement a method in accordance with embodiments of the disclosure; and

FIG. 9 shows schematically the structure of a communication device which may be used in the computerised network of FIG. 1 to implement a method in accordance with embodiments of the disclosure.

Corresponding reference numerals indicate corresponding parts throughout the several views of the drawings.

### DETAILED DESCRIPTION

Embodiments will be described, by way of example only, with reference to the drawings. The description and specific examples included herein are intended for purposes of illustration only and are not intended to limit the scope of the present disclosure.

As used herein, the term “account” refers to any form of arrangement that a customer has with an institution that allows the customer to deposit and/or withdraw funds. An account can be a deposit account, a credit card account, a debit card account, a current account, a savings account, an overdraft account, an electronic wallet account or any other type of account offered by the institution. Furthermore, the account may be a loan account in which case the customer owes money to the institution. In some embodiments, an account may be associated with a payment card, such as a credit card, a debit card, a prepaid card, a charge card, a membership card, a promotional card, a frequent flyer card, an identification card, a prepaid card, a gift card, and/or any other device that may hold account information, such as mobile phones, smartphones, personal digital assistants (PDAs), key fobs, transponder devices, NFC-enabled devices, and/or computers.

The term “institution” is not necessarily limited to organizations which are legally constituted as banks, since in some jurisdictions other organizations may be permitted to maintain accounts. For example, an institution associated with an acquirer or an issuer can be one of the following: a bank, a financial technology company, or a financial institution.

The terms “component,” “module,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Moreover, the claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable medium embedded with a computer executable program, which encompasses a computer program accessible from any computer-readable storage device or storage media. For example, computer readable media can include, but are not limited to, magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ).

In general terms, the present disclosure proposes a computer system and computer-implemented method for processing a card-based email payment. In some embodiments, registered cardholders will be allocated an email address which includes both the card number and payment network (e.g., [cardnumber] @ [paymentnetwork].com). Using this address, users can instruct a payment to another user via email or an issuer application, using ordinary language, if they know the other users' card number or registered email address (e.g., send $100 to [cardnumber]@[paymentnetwork].com). Payments may be initiated either from an internet banking application or they can be carried out directly from an email application (e.g., Outlook). There may be no need for one time password (OTP) authentication. In the case where the payment is initiated from an internet banking application, an issuer server associated with the internet banking application will forward the request to the payment network server, otherwise the payment network server will receive it directly from the email. The payment network will identify the beneficiary bank from the recipient's card number and will send a notification to the beneficiary bank for them to validate the recipient's card number and fetch the account details associated with the recipient's card number for receipt of the payment. The beneficiary bank will confirm the same to the payment network server, which in turn will confirm the same to the user's issuer bank for debiting of the user's account. Finally, an email confirmation may be sent to the user and/or beneficiary.

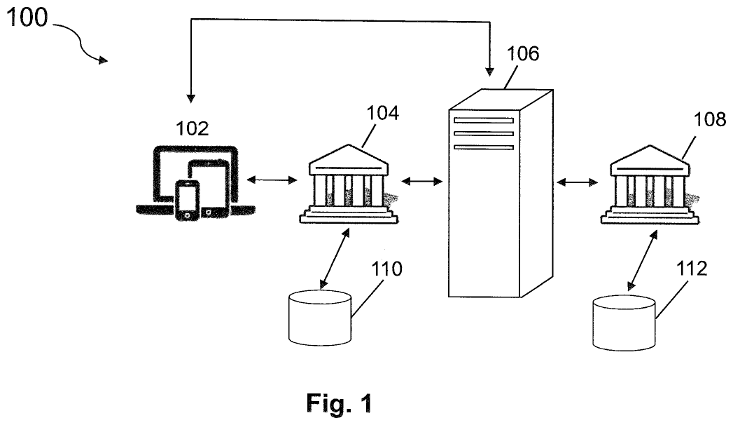

Referring to FIG. 1, an example of a computerised network 100 for processing a card-based email payment in accordance with a first embodiment of the disclosure, is shown. The computerised network 100 comprises a user device 102 in the form of a smartphone, tablet, laptop or desktop computer, or the like, a sender issuer server 104, a payment network server 106 and a receiver issuer server 108. A user database 110 is in communication with the sender issuer server 104 and a customer database 112 is in communication with the receiver issuer server 108. The operation of each component in the computerised network 100 will be described in more detail below. It should be understood that in practice multiple user devices 102, sender issuer servers 104 and receiver issuer servers 108 may be employed in the computerised network 100. Furthermore, the sender issuer server 104 and the receiver issuer server 108 may relate to the same issuer server where the sender and recipient both have accounts with the same issuer institution.

The user device 102 is configured to run an email application (e.g., Outlook) and/or an issuer application or website operated by the sender issuer server 104 for allowing the user to access internet banking facilities associated with a sender's card account. The user device 102 may therefore be used to initiate a card-based email payment either through the email application or issuer application.

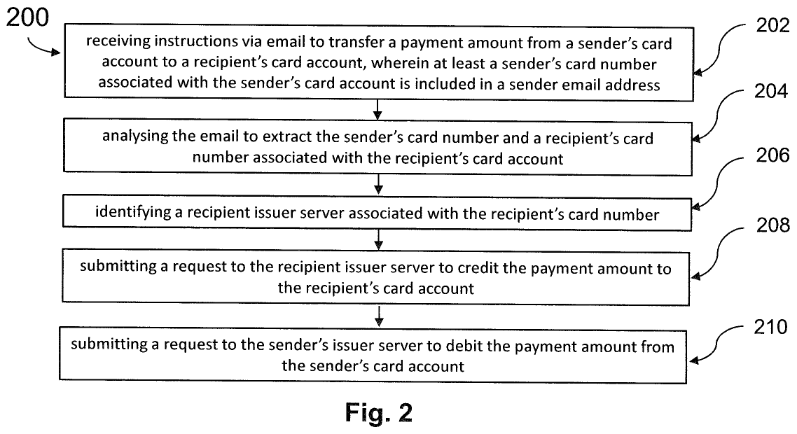

The payment network server 106 comprises at least a computer processor and a data storage device, the data storage device comprising instructions operative by the processor to carry out a method 200 for processing a card-based email payment as shown in FIG. 2. Thus, the method 200 comprises:
a) a step 202 of receiving instructions via email to transfer a payment amount from a sender's card account to a recipient's card account, wherein at least a sender's card number associated with the sender's card account is included in a sender email address;
b) a step 204 of analysing the email to extract the sender's card number and a recipient's card number associated with the recipient's card account;
c) a step 206 of identifying a recipient issuer server associated with the recipient's card number;
d) a step 208 of submitting a request to the recipient issuer server to credit the payment amount to the recipient's card account; and
e) a step 210 of submitting a request to the sender's issuer server to debit the payment amount from the sender's card account.

Steps d) and e) may be performed in any order or concurrently.

The email may be received by the payment network server 106 directly from the user device 102 (i.e., via an email application). In some embodiments, the email may be routed from the user device 102 to the payment network server 106 via the issuer server 104. In embodiments where the user device 102 is used to instruct the card-based email payment via an issuer application, the instructions may be sent via email or otherwise to the issuer server 104 and from the issuer server 104 to the payment network server 106 via email.

Accordingly, embodiments of the disclosure provide a payment network server 106 configured to obtain a sender's card number directly from an email and to instruct a receiver issuer server 108 to credit a payment amount to a recipient's card account, using only the recipient's card number identified from the email, thus minimising processing time and hardware set-up and maintenance costs.

The recipient's card number may be provided in the email or included in a recipient email address used in the email. Thus, the recipient's card number may also be extracted directly from the email without the need to consult a separate database thereby saving time and cost.

In some embodiments, the issuer server 104 may store payee details in the user database 110 on instruction by a user. Thus, a user may store an identifier (e.g., in the form of a name, number or code) to be associated with a recipient's card number such that the identifier may be used instead of the recipient's card number in the email instructing a card-based email payment. By way of example, a user may instruct a card-based email payment via an email or issuer application using any of the following:
1) Send $200 to person X
2) Pay $100 to company Y
3) Pay my rent

For examples 1) and 2) the user must have saved the recipient's card numbers associated with person X and company Y, respectively, in the user database 110 such that on receipt of the instructions from the user device 102, the issuer server 104 checks whether a recipient card number is included in the instructions received and, if not, queries the user database 110 to identify the recipient's card number by identifying a string of one or more characters in the instructions as the identifier (i.e. person X or company Y) and matches this with the payee details associated with the user (i.e. associated with the sender's card account).

In the case of example 3), the issuer server 104 would recognise the word ‘rent’ as an identifier and look up ‘rent’ in the user's payee details to identify not only the recipient's card number for payment of the user's rent but also the payment amount to be submitted for the user's rent. Further details may also be included in the payee details (e.g., a user identifier or reference number may be provided to be included in the instructions to be sent to the payment network server 106 for carrying out the card-based email payment).

The sender email address and/or the recipient email address may include identification of the payment network server 106. In some embodiments, the payment network server 106 may be identified via an email domain. For example, the sender email address and/or the recipient email address may be of the format [cardnumber]@[paymentnetwork].com. Thus, the sender need not copy in a system address to process the card-based email payment as the payment network server 106 may operate the email domain and may automatically receive emails using that email domain.

The payment amount may be provided in a content, a subject or an attachment to the email.

The sender's card number and/or the recipient's card number may each, respectively, identify one of a credit card or a debit card.

The payment network server 106 may be further configured to send an email confirmation to the sender email address and/or the recipient email address on successful completion of the card-based email payment.

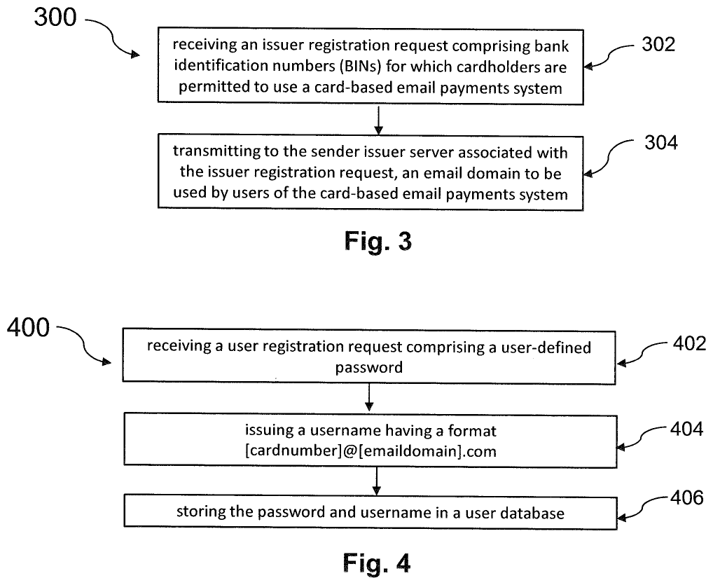

FIG. 3 shows the steps of a method 300 for registering a sender issuer server 104 with a payment network server 106 for processing a card-based email payment in accordance with an embodiment of the disclosure. The method 300 comprises a step 302 of a payment network server 106 receiving an issuer registration request from a sender issuer server 104. The issuer registration request comprising bank identification numbers (BINs) for which cardholders are permitted to use a card-based email payments system as described above. A step 304 includes transmitting to the sender issuer server 104 associated with the issuer registration request, an email domain (e.g., a payment network server identifier) to be used by users of the card-based email payments system. The sender issuer server 104 may submit the issuer registration request via a payment network server portal which provides an option for an issuer institution to register for card-based email banking.

FIG. 4 shows the steps of a method 400 for registering a user for a card-based email payment in accordance with an embodiment of the disclosure. The sender issuer server 104 may be configured for registering users for card-based email payments by: a step 402 of receiving a user registration request comprising a user-defined password (e.g. via an option for card-based email banking which is provided on an issuer application or website); a step 404 of issuing a username having a format [cardnumber]@[emaildomain].com; and a step 406 of storing the password and username in a user database.

The payment network server 106 may request that the sender issuer server 104 verifies login credentials for a user by checking the password and the username provided via an email application for use of the card-based email payments system.

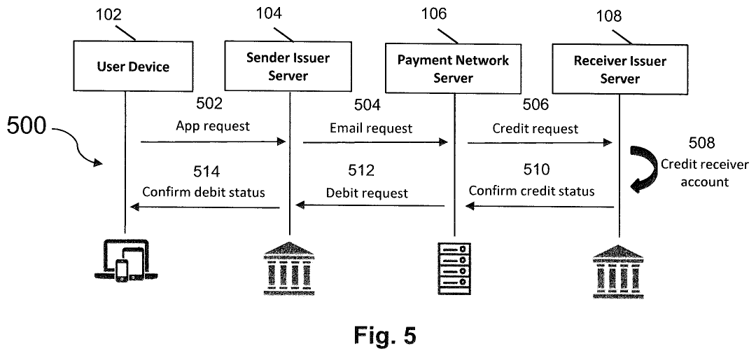

FIG. 5 shows the steps of a method 500 for processing a card-based email payment via an issuer application in accordance with an embodiment of the disclosure. A user logs onto the issuer application using a preset password and username. In a step 502, the user sends a request for a card-based email payment through the issuer application (App) on the user device 102 to the sender issuer server 104. The sender issuer server 104 then sends the request via email to the payment network server 106 in a step 504. The request includes the payment amount, the sender's card number associated with the sender's card account, and the receiver's card number associated with the receiver's card account. The payment amount will be determined by the user and input via the issuer application. The sender's card number may be provided by the sender issuer server 104 based on logon credentials input by the user when logging onto the issuer application. The receiver's card number may be input by the user via the issuer application. In some embodiments, the user may have registered payee details with the sender issuer server 104 and therefore an identifier may be input by the user for matching with payee details stored in the user database 110 to retrieve an associated receiver's card number.

The payment network server 106, on receipt of the email instructions from the sender issuer server 104, will analyse the receiver's card number (i.e., by matching the first six digits to pre-registered codes identifying card issuer servers) and, in a step 506, will send a request to the identified receiver issuer server 108 to credit the receiver's account associated with the receiver card number, with the payment amount. If the payment network server 106 determines that the receiver's card number cannot be used to match with a pre-registered issuer server or that the receiver's card number was issued by another payment network, the payment network server 106 will forward the request to the relevant payment network for processing in a standard manner to credit and debit the appropriate accounts.

In a step 508, the receiver issuer server 108 will identify the receiver's account associated with the receiver card number and will credit the payment amount to the receiver's account before confirming the same to the payment network server 106 in a step 510. If the receiver's account cannot be identified by the receiver issuer server 108, it will notify the payment network server 106 that the crediting has not been successful.

If the crediting has been successful, the payment network server 106 will send a request to the sender issuer server 104 to debit the payment amount from the sender account associated with the sender card number, in a step 512. The sender issuer server 104 will identify the sender's account associated with the sender card number and will debit the payment amount to the sender's account before confirming the same to the user device 102 in a step 514. If the sender's account cannot be identified by the sender issuer server 104, it will notify the user device 102 that the debiting has not been successful via the issuer application. The user may then be prompted to re-enter some or all of the details for the payment request so these can be checked and the payment completed.

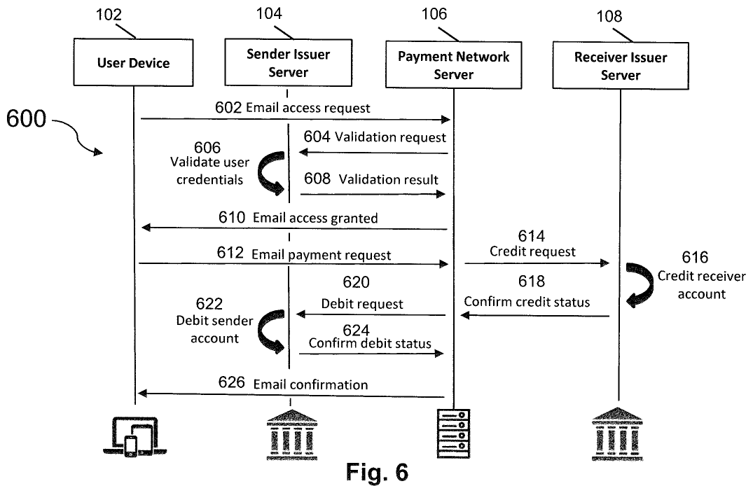

FIG. 6 shows the steps of a method 600 for processing a card-based email payment via an email application (e.g., Outlook) in accordance with an embodiment of the disclosure. A user logs onto the email application using a preset password and a username in the format [cardnumber]@[emaildomain].com as established during the registration process discussed above and outlined in FIG. 4. In a step 602, the user device 102 sends the entered password and username in a request for email access, to the payment network server 106. The payment network server 106, on receipt of the email instructions from the user device 102, will analyse the sender's card number (i.e., by matching the first six digits of the sender's email address with pre-registered codes identifying card issuer servers) and, in a step 604, will send a request to the identified sender issuer server 104 to validate the user's logon credentials (i.e., password and username). In a step 606, the sender issuer server 104 will validate the user's logon credentials by checking whether the password and username match a registered entry in the user database 110. If the password and username are validated, the sender issuer server 104 will inform the payment network server 106 that the validation is successful, in a step 608, and, in a step 610, the payment network server 106 will grant the user access to the email application via the user device 102.

Once successfully logged onto the email application, in a step 612, the user sends a request for a card-based email payment via an email sent through the email application on the user device 102. The email may be addressed to the recipient (via a recipient email address) although it will be received by the payment network server 106 who manages the email domain. The request is sent in the form of an email and includes the payment amount, the sender's card number associated with the sender's card account, and the receiver's card number associated with the receiver's card account. The payment amount will be determined by the user and input into the email content or subject. The sender's card number will be provided by the username and included in the sender's email address. The receiver's card number may be input by the user into the email or it may be included in the receiver's email address if the receiver is also registered for making card-based email payments. In some embodiments, the user may have registered payee details with the sender issuer server 104 and therefore an identifier may be input by the user for matching with payee details stored in the user database 110 to retrieve an associated receiver's card number. In this case, the payment network server 106 may request the receiver's card number associated with the identifier, from the sender issuer server 104.

The payment network server 106, on receipt of the email instructions from the user device 102, will analyse the receiver's card number (i.e., by matching the first six digits to pre-registered codes identifying card issuer servers) and, in a step 614, will send a request to the identified receiver issuer server 108 to credit the receiver's account associated with the receiver card number, with the payment amount. If the payment network server 106 determines that the receiver's card number cannot be used to match with a pre-registered issuer server or that the receiver's card number was issued by another payment network, the payment network server 106 will forward the request to the relevant payment network for processing in a standard manner to credit and debit the appropriate accounts.

In a step 616, the receiver issuer server 108 will identify the receiver's account associated with the receiver card number and will credit the payment amount to the receiver's account before confirming the same to the payment network server 106 in a step 618. If the receiver's account cannot be identified by the receiver issuer server 108, it will notify the payment network server 106 that the crediting has not been successful.

If the crediting has been successful, the payment network server 106 will send a request to the sender issuer server 104 to debit the payment amount from the sender account associated with the sender card number, in a step 620. The sender issuer server 104 will identify the sender's account associated with the sender card number and will debit the payment amount to the sender's account before confirming the same to the payment network server 106 in a step 624. If the sender's account cannot be identified by the sender issuer server 104, it will notify the payment network server 106 that the debiting has not been successful via the issuer application. The user may then be prompted to re-enter some or all of the details for the payment request so these can be checked and the payment completed. If the debiting is completed successfully, the payment network server 106 will send a confirmation email to the sender email address for viewing on the user device 102, in a step 626.

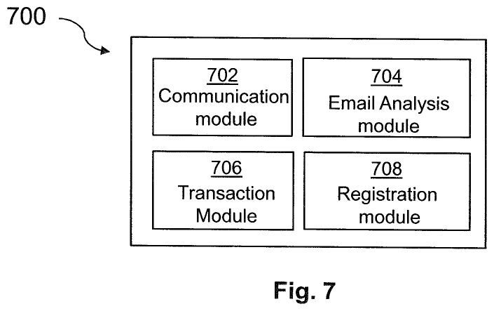

FIG. 7 shows schematically the functional structure 700 of the payment network server 106 comprised in the computerised network 100 of FIG. 1 to carry out the methods of FIGS. 2 to 6 in accordance with an embodiment of the disclosure. The structure 700 of the payment network server 106 comprises a communication module 702, an email analysis module 704, a transaction module 706 and a registration module 708.

The communication module 702 is configured to enable the payment network server 106 to communicate with at least the user device 102, the sender issuer server 104 and the receiver issuer server 108, as provided in the computerised network 100. The communication module 702 is configured to work in tandem with other modules of the payment network server 106 as discussed in more detail below.

The email analysis module 704 is configured to work with the communication module 702 to receive, via email, a request for a card-based email payment either from an email application running on a user device 102 or from an issuer application via a sender issuer server 104. The email will contain at least the sender's card number, the receiver's card number and the payment amount. The email analysis module 704 will analyse the email to extract the sender's card number, the receiver's card number and the payment amount, for example, using a text recognition module trained or configured to recognise card numbers and payment amounts. The email analysis module 704 will also be configured to identify a receiver issuer server 108 from the receiver's card number (i.e., by matching the first six digits to pre-registered codes identifying card issuer servers).

The transaction module 706 is configured to work with the communication module 702 to transmit a request to the identified receiver issuer server 108 to credit the receiver's account associated with the receiver card number, with the payment amount. The transaction module 706 is also configured to work with the communication module 702 to transmit a request to the sender issuer server 104 to debit the payment amount from the sender account associated with the sender card number.

The registration module 708 is configured to work with the communication module 702 to register a sender issuer server 104 in accordance with method 300 of FIG. 3. Thus, the registration module 708 will receive an issuer registration request from a sender issuer server 104, the issuer registration request comprising bank identification numbers (BINs) for which cardholders are permitted to use the card-based email payments system. The registration module 706 will also transmit to the sender issuer server 104 associated with the issuer registration request, an email domain (e.g., a payment network server identifier) to be used by users of the card-based email payments system.

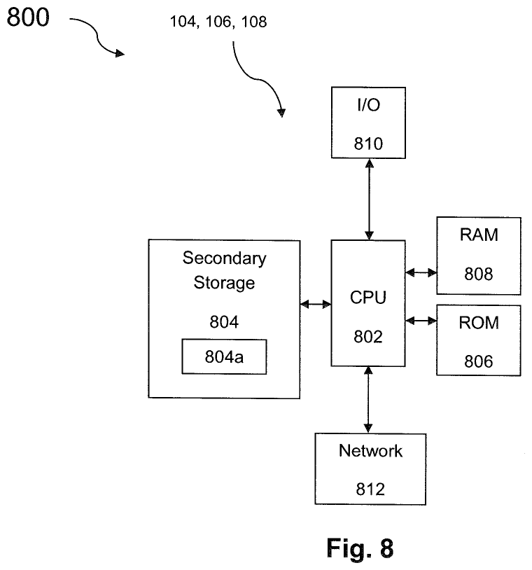

FIG. 8 is a block diagram showing a technical architecture 800 of the payment network server 106. The sender issuer server 104 and the receiver issuer server 108 may also have the same technical architecture 800.

The technical architecture 800 includes a processor 802 (which may be referred to as a central processor unit or CPU) that is in communication with memory devices including secondary storage 804 (such as disk drives), read only memory (ROM) 806, and random access memory (RAM) 808. The processor 802 may be implemented as one or more CPU chips. The technical architecture may further comprise input/output (I/O) devices 810, and network connectivity devices 812.

The secondary storage 804 is typically comprised of one or more disk drives or tape drives and is used for non-volatile storage of data and as an over-flow data storage device if RAM 808 is not large enough to hold all working data. Secondary storage 804 may be used to store programs which are loaded into RAM 808 when such programs are selected for execution.

In this embodiment, the secondary storage 804 has a processing component 804a comprising non-transitory instructions operative by the processor 802 to perform various operations of the method of the present disclosure. The ROM 806 is used to store instructions and perhaps data which are read during program execution. The secondary storage 804, the RAM 808, and/or the ROM 806 may be referred to in some contexts as computer readable storage media and/or non-transitory computer readable media.

I/O devices 810 may include printers, video monitors, liquid crystal displays (LCDs), plasma displays, touch screen displays, keyboards, keypads, switches, dials, mice, track balls, voice recognizers, card readers, paper tape readers, or other input devices.

The network connectivity devices 812 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols, such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other network devices. These network connectivity devices 812 may enable the processor 802 to communicate with the Internet or one or more intranets. With such a network connection, it is contemplated that the processor 802 might receive information from the network, or might output information to the network in the course of performing the above-described method operations. Such information, which is often represented as a sequence of instructions to be executed using processor 802, may be received from and outputted to the network, for example, in the form of a computer data signal embodied in a carrier wave.

The processor 802 executes instructions, codes, computer programs, scripts which it accesses from hard disk, floppy disk, optical disk (these various disk based systems may all be considered secondary storage 804), flash drive, ROM 806, RAM 808, or the network connectivity devices 812. While only one processor 802 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 800 to provide the functionality of a number of servers that is not directly bound to the number of computers in the technical architecture 800. In an embodiment, the functionality disclosed above may be provided by executing an application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture, at least one of the CPU 802, the RAM 808, and the ROM 806 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

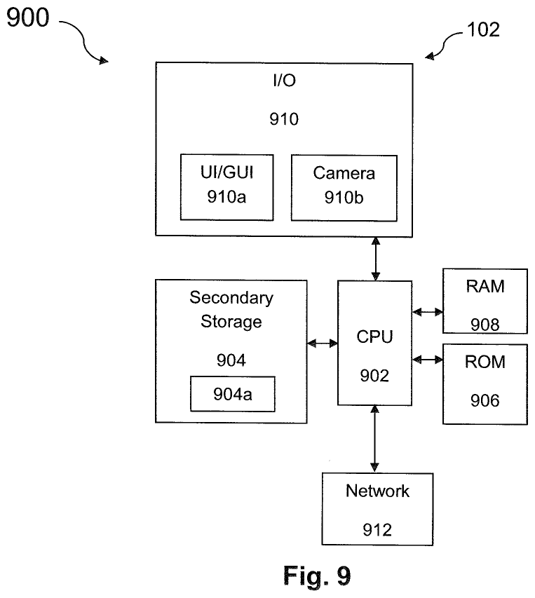

FIG. 9 is a block diagram showing a technical architecture 900 of a communication device (e.g., the user device 102). The technical architecture includes a processor 902 (which may be referred to as a central processor unit or CPU) that is in communication with memory devices including secondary storage 904 (such as disk drives or memory cards), read only memory (ROM) 906, and random access memory (RAM) 908. The processor 902 may be implemented as one or more CPU chips. The technical architecture further comprises input/output (I/O) devices 910, and network connectivity devices 912.

The I/O devices 910 comprise a customer interface (UI) 910a and a camera 910b. The UI 910a may comprise a screen in the form of a touch screen, a keyboard, a keypad or other known input devices. The camera 910b is a device for recording visual images in the form of photographs, film or video signals. The UI 910a may be configured to operate with the processor 902 together with the memory devices 904, 906, 908 in conjunction with the network connectivity devices 912 to display to the customer an authentication request requesting for a customer authentication identifier to be input via the I/O devices 910. The customer authentication identifier may be input via the UI 910a or the camera 910b (e.g., if the customer authentication identifier is associated with a biometric identifier).

The secondary storage 904 is typically comprised of a memory card or other storage device and is used for non-volatile storage of data and as an over-flow data storage device if RAM 908 is not large enough to hold all working data. Secondary storage 904 may be used to store programs which are loaded into RAM 908 when such programs are selected for execution.

In this embodiment, the secondary storage 904 has a processing component 904a, comprising non-transitory instructions operative by the processor 902 to perform various operations of the method of the present disclosure. The ROM 906 is used to store instructions and perhaps data which are read during program execution. The secondary storage 904, the RAM 908, and/or the ROM 906 may be referred to in some contexts as computer readable storage media and/or non-transitory computer readable media.

The network connectivity devices 912 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols, such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other network devices. These network connectivity devices 912 may enable the processor 902 to communicate with the Internet or one or more intranets. With such a network connection, it is contemplated that the processor 902 might receive information from the network, or might output information to the network in the course of performing the above-described method operations. Such information, which is often represented as a sequence of instructions to be executed using processor 902, may be received from and outputted to the network, for example, in the form of a computer data signal embodied in a carrier wave. In embodiments, the network connectivity devices 912 enable the user device 102 and the payment network server 106 to be communicatively connected to each other. The network connectivity devices 912 may also enable the user device 102 to be in communication with the sender issuer server 104.

The processor 902 executes instructions, codes, computer programs, scripts which it accesses from hard disk, floppy disk, optical disk (these various disk based systems may all be considered secondary storage 904), flash drive, ROM 906, RAM 908, or the network connectivity devices 912. While only one processor 902 is shown, multiple processors may be present. Thus, while instructions may be discussed as executed by a processor, the instructions may be executed simultaneously, serially, or otherwise executed by one or multiple processors. In an embodiment, if an App compatible with the authentication process is used, the processor 902 is configured to execute the App stored in the ROM 906 and/or RAM 908 or the secondary storage 904 for processing a card-based email payment as described in the exemplary embodiments.

Whilst the foregoing description has described exemplary embodiments, it will be understood by those skilled in the art that many variations of the embodiments can be made within the scope of the present disclosure as defined by the claims. Moreover, features of one or more embodiments may be mixed and matched with features of one or more other embodiments.

With that said, and as described, it should be appreciated that one or more aspects of the present disclosure transform a general-purpose computing device into a special-purpose computing device (or computer) when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. And, again, the terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the term “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

It is also noted that none of the elements recited in the claims herein are intended to be a means-plus-function element within the meaning of 35 U.S.C. § 112(f) unless an element is expressly recited using the phrase “means for,” or in the case of a method claim using the phrases “operation for” or “step for.”

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A payment network server for processing a card-based email payment, the server comprising at least a computer processor and a data storage device, the data storage device comprising computer-executable instructions, which when executable by the processor, cause the processor to:
(a) receive payment instructions via email to transfer a payment amount from a sender's card account to a recipient's card account, wherein at least a sender's card number associated with the sender's card account is included in a sender email address;
(b) analyse the email to extract the sender's card number and a recipient's card number associated with the recipient's card account;
(c) identify a recipient issuer server associated with the recipient's card number;
(d) submit a request to the recipient issuer server to credit the payment amount to the recipient's card account; and
(e) submit a request to the sender's issuer server to debit the payment amount from the sender's card account.

2. The server according to claim 1, wherein the sender's card number and/or the recipient's card number each, respectively, identify one of a credit card or a debit card.

3. The server according to claim 1, wherein the payment instructions are provided via an email application.

4. The server according to claim 1, wherein the payment instructions are provided via an email request from a sender issuer server associated with the sender's card account.

5. The server according to claim 1, wherein the recipient's card number is provided in the email or included in a recipient email address used in the email.

6. The server according to claim 1, wherein the sender email address includes identification of the server.

7. The server according to claim 1, wherein the server is identified via an email domain.

8. The server according to claim 1, wherein the sender email address is of the format [cardnumber]@[paymentnetwork]com.

9. The server according to claim 1, wherein the payment amount is provided in a content, a subject or an attachment to the email.

10. The server according to claim 1, wherein steps (d) and (e) are performed in any order.

11. The server according to claim 1, wherein steps (d) and (e) are performed concurrently.

12. The server according to claim 1, wherein the computer-executable instructions, when executed by the processor, further cause the processor to send an email confirmation to the sender email address on successful completion of the card-based email payment.

13. The server according to claim 1, wherein the computer-executable instructions, when executed by the processor in connection with registering issuers for card-based email payments, further cause the processor to:
receive an issuer registration request comprising bank identification numbers (BINs) for which cardholders are permitted to use a card-based email payments system; and
transmit to an issuer server associated with the issuer registration request, an email domain to be used by users of the card-based email payments system such that the issuer server may issue a username having a format [cardnumber]@[emaildomain].com.

14. The server according to claim 13, wherein the computer-executable instructions, when executed by the processor, further cause the processor to request that the issuer server verify login credentials for a user by checking a user-defined password and username provided via an email application for use of the card-based email payments system.

15. The server according to claim 13, wherein the issuer server stores payee details in a user database on instruction by a user and the payee details comprise an identifier associated with the recipient's card number such that when the identifier is used instead of the recipient's card number to initiate a card-based email payment, the issuer server includes the recipient's card number in the instructions received by the payment network server.

16. A computer-implemented method for processing a card-based email payment, the method comprising:
receiving instructions via email to transfer a payment amount from a sender's card account to a recipient's card account, wherein at least a sender's card number associated with the sender's card account is included in a sender email address;
analyzing the email to extract the sender's card number and a recipient's card number associated with the recipient's card account;
identifying a recipient issuer server associated with the recipient's card number;
submitting a request to the recipient issuer server to credit the payment amount to the recipient's card account; and
submitting a request to the sender's issuer server to debit the payment amount from the sender's card account.

17. A non-transitory computer-readable storage medium having stored thereon program instructions, which when executed by at least one processor, cause the at least one processor to:
receive payment instructions via email to transfer a payment amount from a sender's card account to a recipient's card account, wherein at least a sender's card number associated with the sender's card account is included in a sender email address;
analyze the email to extract the sender's card number and a recipient's card number associated with the recipient's card account;
identify a recipient issuer server associated with the recipient's card number;
submit a request to the recipient issuer server to credit the payment amount to the recipient's card account; and
submit a request to the sender's issuer server to debit the payment amount from the sender's card account.
